(19) United States
(12) Patent Application Publication
(10) Pub. No.: US 2014/0247505 A1
(43) Pub. Date: Sep. 4, 2014

(54) ZOOM LENS

(71) Applicant: ABILITY ENTERPRISE CO., LTD., New Taipei City (TW)

(72) Inventor: Huai-Yi HUANG, New Taipei City (TW)

(73) Assignee: ABILITY ENTERPRISE CO., LTD., New Taipei City (TW)

(21) Appl. No.: 14/166,818

(22) Filed: Jan. 28, 2014

(30) Foreign Application Priority Data
Mar. 1, 2013 (TW) 102107240

(51) Int. Cl. G02B 15/14; G02B 15/20

(52) U.S. Cl. CPC G02B 15/14; G02B 15/20
USPC 359/684; 359/686; 359/687

(57) ABSTRACT

An embodiment of this invention provides a zoom lens, which comprises a plurality of lens groups in order from an object side to an image-forming side with positive, negative, positive, and positive refractive power respectively. The lens groups comprise a plurality of aspheric lenses and/or free form lenses and a plurality of plastic lenses. The zoom lens satisfies the following equation: DG/fw<3.5 and TTL/fw<15.5, wherein DG denotes the total summation of the thickness of each lens group, fw denotes the focal length of the zoom lens at the wide-angle end, and TTL denotes a total thickness of the zoom lens at the wide-angle end.

This application claims the benefit of Taiwan application Serial No. 102107240, filed Mar. 1, 2013, and the subject matter of which is incorporated herein by reference.

### BACKGROUND

1. Technical Field

The present invention relates to a zoom lens, especially to a zoom lens with light weight, high zoom ratio, and good image quality.

2. Description of the Related Art

Image-capturing devices, including but not limited to digital cameras or digital camcorders, typically employ a lens module and an image sensor to capture an image of a target object. The light beam from the target object is refracted and focused on the image sensor via the zooming and focusing operations of the lens module, and then the analog signals of light are turned into digital signals by the image sensor for following image processing, storage, and transmitting.

The lens module of an image-capturing device normally consists of several lens groups. As the total number of the lenses decreases, the cost is lower, and the overall size is reduced. However, lens modules with small numbers of lenses may not satisfy the requirement of high zoom ratio, and lens modules with large numbers of lenses may not satisfy the requirement of light weight.

Therefore, it is in need to provide novel zoom lenses having light weight, high zoom ratio, and good image quality with reduced cost.

### SUMMARY OF THE INVENTION

An object of the embodiments of the present invention is to provide a zoom lens having light weight, high zoom ratio, and good image quality.

Accordingly, one embodiment of the present invention provides a zoom lens that comprises, four lens groups, in order from an object side to an image-forming side, having positive refractive power, negative refractive power, positive refractive power, and positive refractive power, respectively. The lens groups as a whole comprise a plurality of aspheric lenses and/or free-form lens and a plurality of plastic lenses. The zoom lens satisfies the following conditions: DG/fw<3.5 and TTL/fw<15.5, wherein DG denotes the total summation of the thicknesses of the lens groups, fw is a focal length of the zoom lens at a wide-angle end, and TTL is the total length of the zoom lens at a telephoto end.

By the features described above, the present invention provides a zoom lens having light weight, high zoom ratio, and good image quality with reduced cost.

### BRIEF DESCRIPTION OF THE DRAWINGS

FIG. 1 shows the positions of lenses of a zoom lens at the wide-angle end and the telephoto end according a preferred embodiment of the present invention;

FIGS. 2A and 2B show the field curvature charts of the zoom lens according to an embodiment of this invention at the wide-angle end and at the telephoto end, respectively;

FIGS. 3A and 3B show the distortion charts of the zoom lens according to an example of this invention at the wide-angle end and the telephoto end, respectively; and

FIG. 4A and FIG. 4B show the lateral color charts of the zoom lens according to an example of this invention at the wide-angle end and the telephoto end, respectively.

### DETAILED DESCRIPTION OF THE INVENTION

The embodiments of the present invention are described in details with reference to the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known components and process operations are not described in detail in order not to unnecessarily obscure the present invention. Identical or similar elements of the embodiments are designated with the same or similar reference numerals. While drawings are illustrated in details, it is appreciated that the quantity or sizes of the disclosed components may be greater or less than that disclosed, except expressly restricting the amount or the sizes of the components.

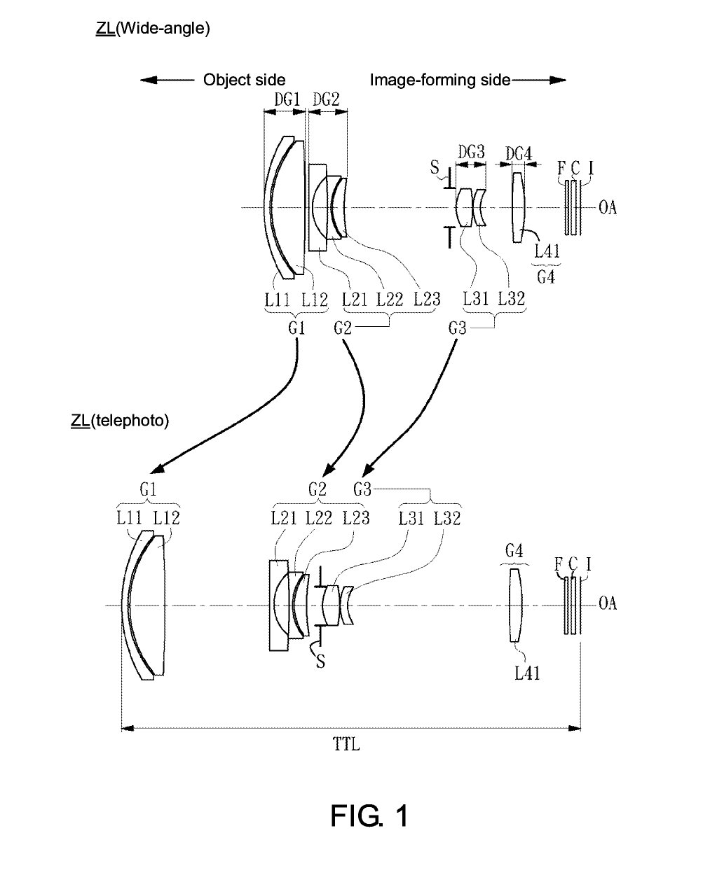

FIG. 1 shows the positions of lenses of a zoom lens ZL at the wide-angle end and at the telephoto end according a preferred embodiment of this invention. To highlight the features of the present embodiment, the drawings merely show components related to this embodiment, and the irrelevant or minor components are omitted. The zoom lens ZL of the present embodiment may be employed in a device capable of projecting images of capturing images, such as a digital camera, a digital camcorder, a cellular phone, or a projector.

As shown in FIG. 1, in the present embodiment, the zoom lens ZL primarily includes four lens groups, in order from an object side to an image-forming side, including a first lens group G1, a second lens group G2, a third lens group G3, and a fourth lens group G4. The four lens groups are arranged along an optical axis OA, and an image-forming surface I is arranged at the image-forming side. The first lens group G1 has positive refractive power, the second lens group G2 has negative refractive power, the third lens group G3 has positive refractive power, and the fourth lens group G4 has positive refractive power. An image sensor having photoelectric conversion function may be disposed on the image-forming surface I.

Still referring to FIG. 1, in one embodiment, the zoom lens ZL satisfies the following conditions: DG/fw<3.5, wherein, DG denotes the total summation of the thickness DG1 of the first lens group, the thickness DG2 of the second lens group, the thickness DG3 of the third lens group, and the thickness DG4 of the fourth lens group; that is, DG=DG1+DG2+DG3+DG4, and fw is the focal length of the zoom lens ZL at the wide-angle end.

In an alternative embodiment, the zoom lens ZL may satisfy the following conditions: TTL/fw<15.5, wherein, TTL is the total length of the zoom lens ZL at a telephoto end, the total length of the zoom lens being defined as the distance between the image-forming surface I and a surface of the first lens group G1 close to the object side, and fw is the focal length of the zoom lens ZL at the wide-angle end.

Moreover, in an alternative embodiment, the zoom lens ZL may further satisfy the following conditions: ft/fw>9.5, which indicates the zoom ratio of the zoom lens ZL may be up to higher than 9.5 times, wherein, ft is the focal length of the zoom lens ZL at the telephoto end, and fw is the focal length of the zoom lens ZL at the wide-angle end.

Still referring to FIG. 1, the zoom lens ZL of the present embodiment including four lens groups, which are the first lens group G1, the second lens group G2, the third lens group G3, and the fourth lens group G4, adopts eight lenses in total. The substantial focal length of the zoom lens ZL may be less than 28 mm, which is equivalent to 135 mm of a conventional film camera. Furthermore, the half image height Y at the wide-angle end may be larger than 3.3 mm but not limited thereto.

In addition, in an alternative embodiment, the diameter of the stop S of the zoom lens ZL of the present invention may be a constant, such that additional iris with adjustable diameter may be omitted. In the present embodiment, an F-number (Fno) of the zoom lens ZL at the wide-angle end may be smaller than 3.6, and an F-number of the zoom lens ZL at the telephoto end may be smaller than 7.0.

Furthermore, in an alternative embodiment, the total length of the zoom lens ZL of the present invention indicates the distance between the image-forming surface I and a surface of the first lens group G1 close to the object side. When the zoom lens ZL is at the retracted position, or the electronic device equipped with the zoom lens ZL is at shut down, the total length of the zoom lens ZL may be less than 18 mm. The total length of the zoom lens ZL is defined as TTL when the zoom lens is at the telephoto end. In practical, when the zoom lens ZL is at the retracted position, at least one of the first, the second, the third, or the fourth lens groups G1-G4 can be removed from the optical axis OA, such that the zoom lens ZL is thinner; however, the invention is not limited thereto.

As shown in FIG. 1, in an alternative embodiment, the zoom lens ZL may further include a filter F. The stop S is arranged between the second lens group G2 and the third lens group G3, for limiting the light flux passing through the first lens group G1 and the second lens group G2 into the third lens group G3. The filter F is arranged between the fourth lens group G4 and the image-forming surface I, for filtering invisible light off the incident light beam. The filter F may be an infrared light filter. In addition, the image-forming surface I is for receiving light beam passing through the filter F. Moreover, a flat lens C, as a cover glass, may be further arranged between the image-forming surface I and the filter F.

In the present embodiment, when the zoom lens ZL is zooming, each of the lens groups can move along the optical axis OA. The first lens group G1, the second lens group G2, and the third lens group G3 move for changing the zoom ratio and fixing aberration, and the fourth lens group G4 moves for focusing.

Still referring to FIG. 1, in an alternative embodiment, the zoom lens ZL includes four aspheric lenses and/or free-form lenses. Precisely, each of the first lens group G1, the second lens group G2, the third lens group G3, and the fourth lens group G4 comprises one or two aspheric lenses, one or two free-form lenses, or one aspheric lens and one free-form lens. The materials of the lens groups may ne plastic of glass. The plastic may comprise, but is not limited to, polycarbonate, cyclic olefin copolymer (e.g. APEL), polyester resins (e.g. OKP4 or OKP4HT), and the like. In addition, each free-form lens has at least one free-form freedom surface, and each aspheric lens has at least one aspheric surface satisfying the following equation:

$$Z = \frac{{CY}^{2}}{1 \vert \sqrt{1 ( K \vert 1 ) {C}^{2} {Y}^{2}}} + {A}_{4} {Y}^{4} + {A}_{6} {Y}^{6} + {A}_{8} {Y}^{8} + {A}_{10} {Y}^{10} + {A}_{12} {Y}^{12}$$

where Z is the coordinate in the optical axis OA direction, and the direction in which light propagates is designated as positive; A₄, A₆, A₈, A₁₀, and A₁₂ are aspheric coefficients; K is coefficient of quadratic surface; C is reciprocal of R (C=1/R); R is the radius of curvature; Y is the coordinate in a direction perpendicular to the optical axis, in which the upward direction is designated as positive. In addition, each of the parameters or the coefficients of the equation of each aspheric lens may be predetermined.

In an alternative embodiment, the first lens group G1 comprises a first lens L11 having negative refractive powder and a second lens L12 having positive refractive powder, in order from the object side to the image-forming side. The second lens group G2 comprises a first lens L21 having negative refractive powder, a second lens L22 having negative refractive powder, and a third lens L23 having positive refractive power, in order from the object side to the image-forming side. The third lens group G3 comprises a first lens L31 having positive refractive powder and a second lens L32 having negative refractive power, in order from the object side to the image-forming side. The fourth lens group G4 comprises a first lens L41 having positive refractive power. In the present embodiment, the first lens L11 may be a negative convex-concave lens having a convex surface toward the object side, and the second lens L12 may be a positive biconvex lens; the first lens L21 may be a negative convex-concave lens having a convex surface toward the object side, the second lens L22 may be a negative convex-concave lens having a convex surface toward the object side, and the third lens L23 may be a positive convex-concave lens having a convex surface toward the object side; the first lens L31 may be a positive biconvex lens, and the second lens L32 may be a negative convex-concave lens having a convex surface toward the object side; the first lens L41 may be a positive biconvex lens; however, the invention is not limited thereto.

In an alternative embodiment, the third lens L23 of the second lens group G2, the first lens L31 and the second lens L32 of the third lens group G3, and the first lens L41 of the fourth lens group G4 may be aspheric lenses or free-form lenses; the first lens L11 and the second lens L12 of the first lens group G1, and the first lens L21 and the second lens L22 of the second lens group G2 may be spherical lenses. Each of the free-form lenses has at least one free-form freedom surface, each of the aspheric lenses has at least one aspheric surface, and the spherical lenses have spherical surfaces on both sides; however, the invention is not limited thereto.

In an alternative embodiment, the first lens L11, the second lens L12, the first lens L21, the second lens L22, and the first lens L31 may be glass lenses made from nitrate materials, and the third lens L23, the second lens L32, and the first lens L41 may be plastic lenses made from plastic materials. Precisely, the glass lenses may be formed from optical grade nitrate materials, and in the present embodiment, the first lens L31 may further be an aspheric lens or a free-form lens fabricated by a polish process or a glass molding process (GMP); the plastic lenses may be formed by an injection molding process or a turning process; however, the invention is not limited thereto.

In addition, in a further embodiment, the third lens L23 has a refractive index of larger than 1.6 and an Abbe number of smaller than 50, the first lens L31 has a refractive index of smaller than 1.6 and an Abbe number of larger than 50, the second lens L32 has a refractive index of larger than 1.6 and an Abbe number of smaller than 50, and the first lens L41 has a refractive index of smaller than 1.6 and an Abbe number of larger than 50; however, the invention is not limited thereto.

Table 1 lists the detail information of the zoom lens ZL as shown in FIG. 1, according to an example of this invention. The detail information includes the curvature radius, the thickness, the refractive index, and the Abbe number of each of the lenses, where the surface numbers are sequentially ordered from the object side to the image-forming side. For example, “S1” stands for the surface of the first lens L11 facing the object side, “S2” stands for the surface of the first lens L11 facing the image-forming side, “STOP” stands for the surface of the stop S, “S18” and “S19” respectively stands for the surface of the filter F facing the object side and the image-forming side, “S20” and “S21” respectively stands for the surface of the flat lens C facing the object side and the image-forming side, and so on.

TABLE 1

| | | Curvature | | | |
|---|---|---|---|---|---|
| | Surface | radius | Thickness | Refractive | Abbe |
| Lens | number | (mm) | (mm) | index | number |
| L11 | S1 | 18.015 | 0.550 | 1.9036 | 31.31 |
| | S2 | 12.178 | 0.285 | | |
| L12 | S3 | 12.382 | 4.000 | 1.6179 | 63.39 |
| | S4 | −229.832 | D1 | | |
| L21 | S5 | 655.565 | 0.450 | 1.804 | 46.57 |
| | S6 | 5.102 | 1.785 | | |
| L22 | S7 | 359.099 | 0.450 | 1.6179 | 63.39 |
| | S8 | 5.778 | 0.060 | | |
| L23 | S9 | 4.717 | 1.590 | 1.636 | 23.95 |
| | S10 | 15.551 | D2 | | |
| Stop S | STOP | Infinity | 0.100 | | |
| L31 | S12 | 4.098 | 2.080 | 1.497 | 81.56 |
| | S13 | −12.209 | 0.100 | | |
| L32 | S14 | 5.821 | 0.800 | 1.636 | 23.95 |
| | S15 | 3.253 | D3 | | |
| L41 | S16 | 19.9945 | 1.40 | 1.544 | 56.11 |
| | S17 | −368.9544 | D4 | | |
| F | S18 | Infinity | 0.3 | 1.5163 | 64.14 |
| | S19 | Infinity | 0.4 | | |
| C | S20 | Infinity | 0.5 | 1.5163 | 64.14 |
| | S21 | Infinity | 0.5 | | |
| Image-forming | I | Infinity | 0.0 | | |
| surface | | | | | |

In table 1, the “thickness” stands for the distance between an indicated surface and an adjacent surface close to the image-forming side. For example, the thickness of the surface S1 is the distance between the surface S1 and the surface S2, and the thickness of the surface S2 is the distance between the surface S2 and the surface S3. When a thickness is labeled with D1, D2, D3, or D4, it indicates that the thickness is a variable depending on the wide-angle end or the telephoto end, and the details are listed in table 2. Meanwhile, table 2 lists the focal lengths of the zoom lens ZL at the wide-angle end and at the telephoto end as well.

TABLE 2

| | Focal length | | |
|---|---|---|---|
| | Wide-angle end | Middle | Telephoto end |
| | Variable thickness | | |
| | (4.558 mm) | (18.2 mm) | (52.546 mm) |
| D1 | 0.450 | 11.39 | 18.274 |
| D2 | 13.415 | 4.131 | 1.1995 |
| D3 | 3.853 | 3.695 | 18.553 |
| D4 | 5.089 | 11.478 | 6.694 |

Furthermore, in the above-mentioned example, the two surfaces of each of the third lens L23, the first lens L31, the second lens L32, and the first lens L41 S7 are designated with S9, S10, S12, S13, S14, S15, S16, and S17, and the aspheric coefficients of the above-mentioned surfaces are listed in table 3.

TABLE 3

| | K | A₄ | A₆ | A₈ | A₁₀ | A₁₂ |
|---|---|---|---|---|---|---|
| S9 | −1.61279 | 1.6515852E−04 | 1.0656106E−04 | −1.4761662E−05 | 1.1421300E−06 | −4.1716816E−08 |
| S10 | −70.93466 | 9.8360230E−04 | −1.5027976E−04 | 1.2663799E−05 | −6.6401900E−07 | 6.3706943E−09 |
| S12 | −0.61782 | −9.8542814E−05 | −3.7869052E−05 | 3.0516880E−05 | −1.0082900E−05 | 5.7229192E−07 |
| S13 | 1.28938 | −1.7849587E−03 | 1.0474785E−03 | −2.5270821E−04 | 1.6353600E−05 | NA |
| S14 | −26.03739 | 1.1248753E−02 | −3.4661721E−03 | 8.5073249E−04 | −1.3787200E−04 | 9.2716455E−06 |
| S15 | −9.22971 | 2.9691455E−02 | −9.0315257E−03 | 2.5781745E−03 | −4.2620600E−04 | 2.9644670E−05 |
| S16 | 0 | −5.3887627E−04 | −9.8257659E−05 | 1.3649309E−05 | −1.0291500E−06 | 2.7935928E−08 |
| S17 | 0 | −4.4499780E−04 | −1.2893280E−04 | 1.6328698E−05 | −1.0964600E−06 | 2.7275642E−08 |

In one embodiment, the focal length fw of the zoom lens ZL at the wide-angle end may be 4.25-5.00 mm, and DG may be smaller than 14.85 mm; accordingly, DG/fw is about 2.97-3.474 and smaller than 3.5. In the present embodiment, the focal length fw of the zoom lens ZL at the wide-angle end is 4.558 mm, DG is 14.25, and thus DG/fw=3.16.

In one embodiment, the focal length ft of the zoom lens ZL at the telephoto end is 40.37-62.5 mm, and accordingly, the zoom ratio ft/fw of the zoom lens ZL is 9.5-12.5 and equal to or larger than 9.5. In the present embodiment, the focal length ft of the zoom lens ZL at the telephoto end is 52.546 mm, and accordingly, the zoom ratio ft/fw of the zoom lens ZL is 11.528.

In one embodiment, the total length TTL of the zoom lens ZL may be 55.0-65.5 mm, and accordingly, TTL/fw is about 11.0-15.41 and smaller than 15.5. In the present embodiment, the total length TTL of the zoom lens ZL at the telephoto end is 60.07 mm, and accordingly, TTL/fw is 13.179.

Moreover, in one embodiment, the F number (Fno) of the zoom lens ZL at the wide-angle end may be smaller than 3.6, and the F number of the zoom lens ZL at the telephoto end may be smaller than 7.0. In the present embodiment, the F number of the zoom lens ZL at the wide-angle end is 3.2, and the F number of the zoom lens ZL at the telephoto end is 6.5.

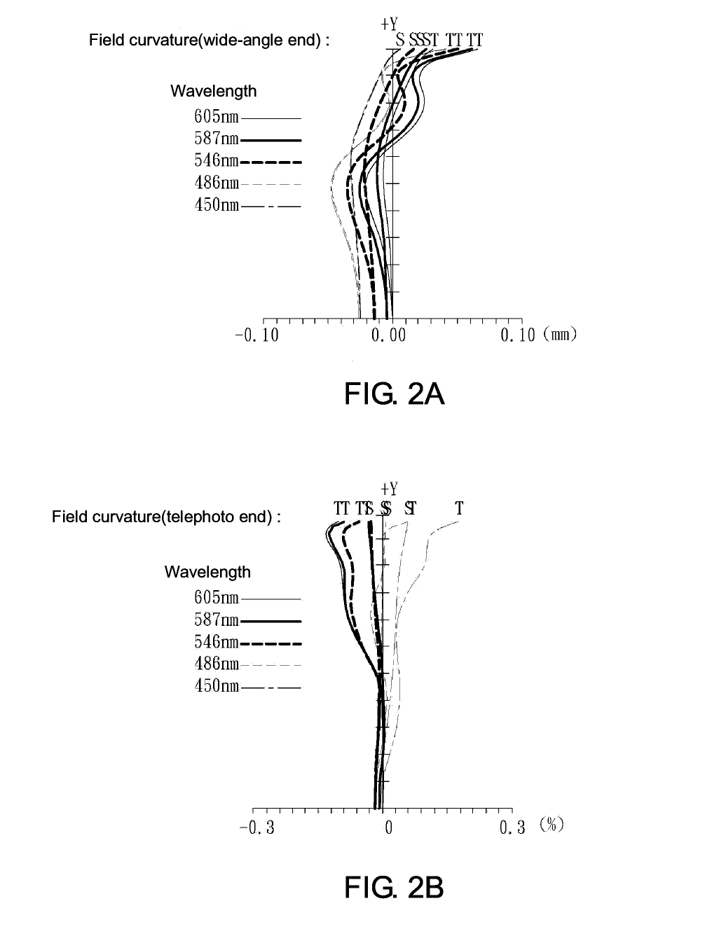

FIGS. 2A and 2B show the field curvature charts of the zoom lens ZL according to an embodiment of this invention at the wide-angle end and at the telephoto end, respectively. The curves T and S stand for the aberration of the zoom lens to the tangential rays and the sagittal rays. In the present embodiment, the tangential values and the sagittal values of light beams with a variety of wavelengths are all set in the range of (−0.05 mm, 0.07 mm) at the wide-angle end, and the tangential values and the sagittal values are all set in the range of (−0.15 mm, 0.18 mm) at the telephoto end.

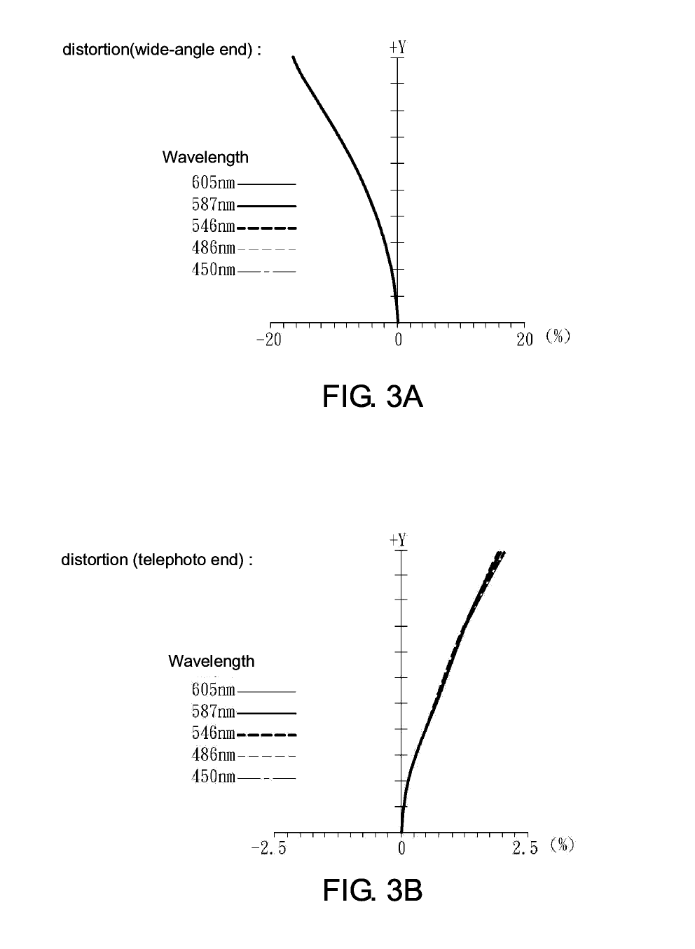

FIGS. 3A and 3B show the distortion charts of the zoom lens ZL according to an example of this invention at the wide-angle end and the telephoto end, respectively. In the present embodiment, the distortion values for light beams with a variety of wavelengths are all set in the range of (−16%, 0%) at the wide-angle end, and the distortion values are all set in the range of (0%, 2.5%) at the telephoto end.

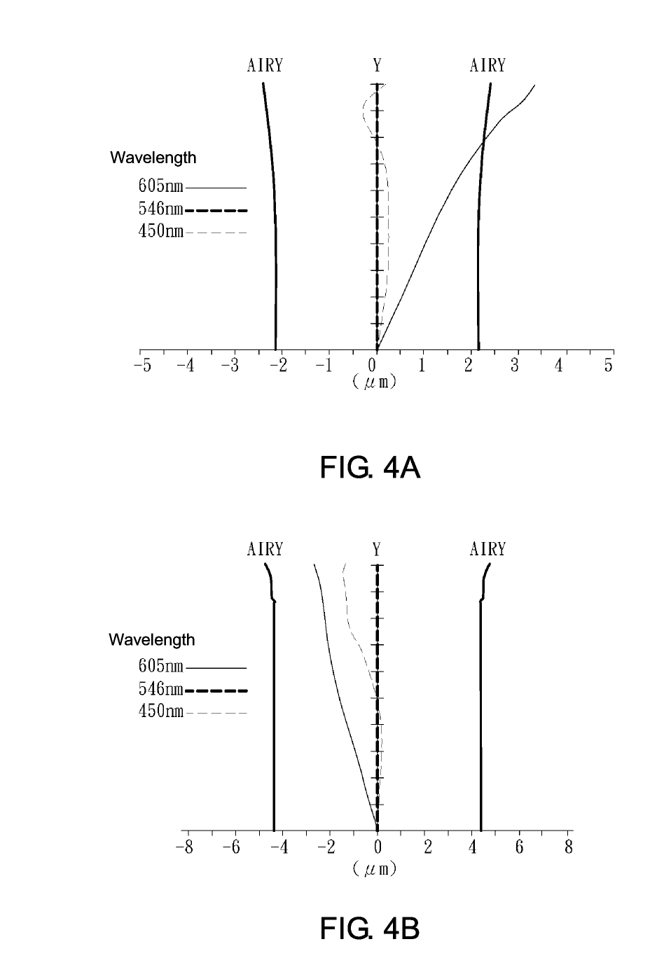

FIG. 4A and FIG. 4B show the lateral color charts of the zoom lens ZL according to an example of this invention at the wide-angle end and the telephoto end, respectively. In the present embodiment, the lateral color aberrations for light beams with a variety of wavelengths are all set in the range of (−0.5 μm, 3.5 μm) at the wide-angle end, and the lateral color aberrations are all set in the range of (−3 μm, 0.5 μm) at the telephoto end.

As shown in FIGS. 2A-4B, according to the embodiments of the present invention, the field curvature, the distortion, and the lateral color aberration of the zoom lens can be properly adjusted. Moreover, the zoom lens of the embodiments of the present invention is provided with advantages of low cost, small size, high zoom ratio, and good image quality.

While the invention has been described by way of example and in terms of the preferred embodiment(s), it is to be understood that the invention is not limited thereto. On the contrary, it is intended to cover various modifications, equivalents, and similar arrangements and procedures, and the scope of the invention is intended to be limited solely by the appended claims.

What is claimed is:

1. A zoom lens, in order from an object side to an image-forming side, comprising: a first lens group, a second lens group, a third lens group and a fourth lens group, wherein the second lens group has negative refractive powder, and each of the second lens group, the third lens group, and the fourth lens group comprises at least one plastic lens.

2. The zoom lens as recited in claim 1, wherein the zoom lens satisfies the following conditions: DG/fw<3.5;
wherein, DG denotes the total summation of the thicknesses of the first lens group, the second lens group, the third lens group and the fourth lens group, and fw is a focal length of the zoom lens at a wide-angle end.

3. The zoom lens as recited in claim 1, wherein the zoom lens satisfies the following conditions: TTL/fw<15.5;
wherein TTL is the total length of the zoom lens at a telephoto end, and fw is a focal length of the zoom lens at a wide-angle end.

4. The zoom lens as recited in claim 1, wherein the zoom lens satisfies the following conditions: ft/fw>9.5;
wherein, ft is a focal length of the zoom lens at a telephoto end,
and fw is a focal length of the zoom lens at a wide-angle end.

5. The zoom lens as recited in claim 1, wherein an F-number of the zoom lens at a wide-angle end is smaller than 3.6, and the F-number of the zoom lens at a telephoto end is smaller than 7.0.

6. The zoom lens as recited in claim 1, wherein the first lens group comprises two lenses having negative refractive powder and positive refractive power, respectively, in order from the object side to the image-forming side.

7. The zoom lens as recited in claim 1, wherein the second lens group comprises three lenses having negative refractive powder, negative refractive powder and positive refractive power, respectively, in order from the object side to the image-forming side, and the lens with positive refractive powder has a refractive index of larger than 1.6 and an Abbe number of smaller than 50.

8. The zoom lens as recited in claim 1, wherein the third lens group comprises two lenses having positive refractive powder and negative refractive power, respectively, in order from the object side to the image-forming side, the lens close to the object side has a refractive index of smaller than 1.6 and an Abbe number of larger than 50, and the lens close to the image-forming side has a refractive index of larger than 1.6 and an Abbe number of smaller than 50.

9. The zoom lens as recited in claim 1, wherein the fourth lens group comprises an aspheric plastic lens or a free-form plastic lens with a refractive index of smaller than 1.6 and an Abbe number of larger than 50.

10. A zoom lens having a focusing lens group, the zoom lens, in order from an object side to an image-forming side, comprising:
a first lens group having positive refractive power;
a second lens group having negative refractive power; and
a third lens group having positive refractive power;
wherein, each of the focusing lens group, the second lens group and the third lens group comprises at least one aspheric lens or free-form lens, and/or each of the focusing lens group, the second lens group and the third lens group comprises a plastic lens.

11. The zoom lens as recited in claim 10, wherein the zoom lens satisfies the following conditions: DG/fw<3.5;
wherein, DG denotes the total summation of the thicknesses of the first lens group, the second lens group, the third lens group and the focusing lens group, and fw is a focal length of the zoom lens at a wide-angle end.

12. The zoom lens as recited in claim 10, wherein the zoom lens satisfies the following conditions: TTL/fw<15.5;
wherein TTL is the total length of the zoom lens at a telephoto end, and fw is a focal length of the zoom lens at a wide-angle end.

13. The zoom lens as recited in claim 10, wherein the zoom lens satisfies the following conditions: ft/fw>9.5;
wherein, ft is a focal length of the zoom lens at a telephoto end, and fw is a focal length of the zoom lens at a wide-angle end.

14. The zoom lens as recited in claim 10, wherein the second lens group comprises three lenses having negative refractive powder, negative refractive powder and positive refractive power, respectively, in order from the object side to the image-forming side, and the lens with positive refractive powder has a refractive index of larger than 1.6 and an Abbe number of smaller than 50.

15. The zoom lens as recited in claim 10, wherein the third lens group comprises two lenses having positive refractive powder and negative refractive power, respectively, in order from the object side to the image-forming side, the lens close to the object side has a refractive index of smaller than 1.6 and an Abbe number of larger than 50, and the lens close to the image-forming side has a refractive index of larger than 1.6 and an Abbe number of smaller than 50.

16. The zoom lens as recited in claim 10, wherein the focusing lens group comprises an aspheric plastic lens or a free-form plastic lens with a refractive index of smaller than 1.6 and an Abbe number of larger than 50.

17. A zoom lens, in order from an object side to an image-forming side, comprising: a first lens group, a second lens group, a third lens group and a fourth lens group respectively having a refractive powder with positive, negative, positive and positive;
wherein the zoom lens satisfies the following conditions:
DG/fw<3.5;
TTL/fw<15.5; and
ft/fw>9.5;
wherein, DG denotes the total summation of the thicknesses of the first lens group, the second lens group, the third lens group and the fourth lens group; TTL is the total length of the zoom lens at a telephoto end; fw is a focal length of the zoom lens at a wide-angle end; and, ft is the focal length of the zoom lens at the telephoto end.

18. The zoom lens as recited in claim 17, wherein the second lens group comprises three lenses having negative, negative and positive refractive power, respectively, in order from the object side to the image-forming side, and the lens with positive refractive powder is an aspheric plastic lens having a refractive index of larger than 1.6 and an Abbe number of smaller than 50.

19. The zoom lens as recited in claim 17, wherein the third lens group comprises two lenses having positive and negative refractive power, respectively, in order from the object side to the image-forming side, the lens having positive refractive powder is an aspheric plastic lens or a free-form plastic lens with a refractive index of smaller than 1.6 and an Abbe number of larger than 50, and the lens having negative refractive powder is an aspheric plastic lens or a free-form plastic lens with a refractive index of larger than 1.6 and an Abbe number of smaller than 50.

20. The zoom lens as recited in claim 17, wherein the fourth lens group comprises an aspheric plastic lens or a free-form plastic lens with a refractive index of smaller than 1.6 and an Abbe number of larger than 50.
